(19) United States
(12) Patent Application Publication
(10) Pub. No.: US 2009/0116633 A1
(43) Pub. Date: May 7, 2009

(54) METHOD FOR DISPLAYING DIALING INFORMATION AND MOBILE COMMUNICATION DEVICE USING THE METHOD

(76) Inventor: Yuan-Mao TSUEI, Taoyuan County (TW)

Correspondence Address: BIRCH STEWART KOLASCH & BIRCH, PO BOX 747, FALLS CHURCH, VA, 22040-0747, US

(21) Appl. No.: 12/239,643

(22) Filed: Sep. 26, 2008

(30) Foreign Application Priority Data
Nov. 1, 2007 (TW) 96141161

(51) Int. Cl. H04M 3/42

(52) U.S. Cl. 379/216.01

(57) ABSTRACT

A method for displaying dialing information is disclosed. A trigger signal generated by pressing a virtual button of a virtual keypad of a mobile communication device is received. It is determined whether the trigger signal corresponds to a dialing operation. If the trigger signal corresponds to the dialing operation, a pattern corresponding to the pressed virtual button is displayed on a portion of the virtual keypad.

### CROSS REFERENCE TO RELATED APPLICATIONS

This Application claims priority of Taiwan Patent Application No. 96141161, filed on Nov. 1, 2007, the entirety of which is incorporated by reference herein.

### BACKGROUND

Generally, when a touch panel of a mobile communication device (a personal digital assistant (PDA), for example) is used to dial a phone number, the touch panel usually comprises two display areas, one is for displaying a soft keypad (virtual keypad, monitor keypad), the other one is for displaying a dialed phone number. As shown in FIG. 1, a touch panel of a mobile communication device 100 comprises two display areas 110 and 120. The display area 110 displays a soft keypad, which is usually located at the lower portion of the touch panel. The display area 120 displays a dialed phone number, which is usually located at the upper portion of the touch panel. In some mobile communication device, another display area 130 is further provided for displaying the contact information corresponding to the dialed phone number.

As described, a touch panel for dialing a phone number usually has two or more display areas, therefore the display area size for the virtual keypad is limited. The display area size for each virtual button of the virtual keypad is so small that neighboring virtual buttons may be accidentally touched when a specific number or symbol of a virtual button is pressed.

Thus, a method for displaying dialing information without reducing the size for displaying virtual buttons of a virtual keypad for a mobile communication device to reduce accidental touch is desirable.

### BRIEF SUMMARY

Methods for displaying dialing information are provided. The method for displaying dialing information comprises the following steps. A trigger signal generated by pressing a virtual button of a virtual keypad of a mobile communication device is received. It is determined whether the trigger signal corresponds to a dialing operation. If the trigger signal corresponds to the dialing operation, a pattern corresponding to the virtual button is overlapping displayed on a portion of the virtual keypad.

Mobile communication devices are provided. The mobile communication device comprises a touch panel, a signal receiving module, and a microcontroller. The touch panel displays a virtual keypad comprising plural virtual buttons. The signal receiving module receives a trigger signal generated by pressing of one of the virtual buttons. The microcontroller receives the trigger signal from the signal receiving module, and determines whether the trigger signal corresponds to a dialing operation. If the trigger signal corresponds to the dialing operation, the microcontroller overlapping displays a pattern corresponding to the virtual button on a portion of the virtual keypad.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a schematic view of dialing phone numbers using a mobile communication device;

FIG. 2 is a schematic view of overlapping and displaying patterns corresponding to virtual buttons on a virtual keypad of the present invention;

FIG. 3 is a flowchart of a method for displaying dialing information of the present invention; and

FIG. 4 is a schematic view of a mobile communication device of the present invention.

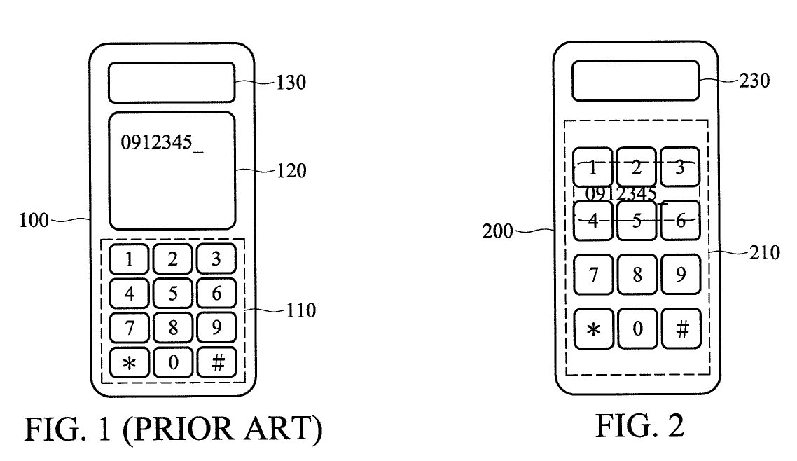

### DETAILED DESCRIPTION

Several exemplary embodiments of the disclosure are described with reference to FIGS. 2 through 4, which generally relate to dialing information display. It is to be understood that the following disclosure provides various different embodiments as examples for implementing different features of the disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

In some embodiments of a method for displaying dialing information of the disclosure, a touch panel of a mobile communication device does not has a display area for displaying pattern(s) corresponding to the pressed virtual button(s), for example a dialed phone number, so that the size of a display area for displaying a virtual keypad is enlarged. The dialed phone numbers is overlapping displayed on the virtual keypad. The disclosure provides a virtual object overlapping display function, whereby one virtual object is displayed above another virtual object.

In some embodiments, a touch panel of a mobile communication device further comprises a display area for displaying contact information, such as a contact name in a contact list and a phone number in a call history, corresponding to the pattern such as a dialed phone number.

FIG. 2 is a schematic view of overlapping displaying patterns corresponding to the pressed virtual buttons on a virtual keypad of the present invention.

A touch panel of a mobile communication device 200 provides display areas 210 and 230. The display area 210 shows a virtual keypad and the display area 230 shows contact information corresponding to the pattern such as a dialed phone number. The dialed phone number is overlapping displayed on the virtual keypad of the display area 210. Since a display area showing the dialed phone number is not additionally provided, the display area 210 can be enlarged so that the size of the virtual buttons of the virtual keypad can be increased to reduce accidental touch.

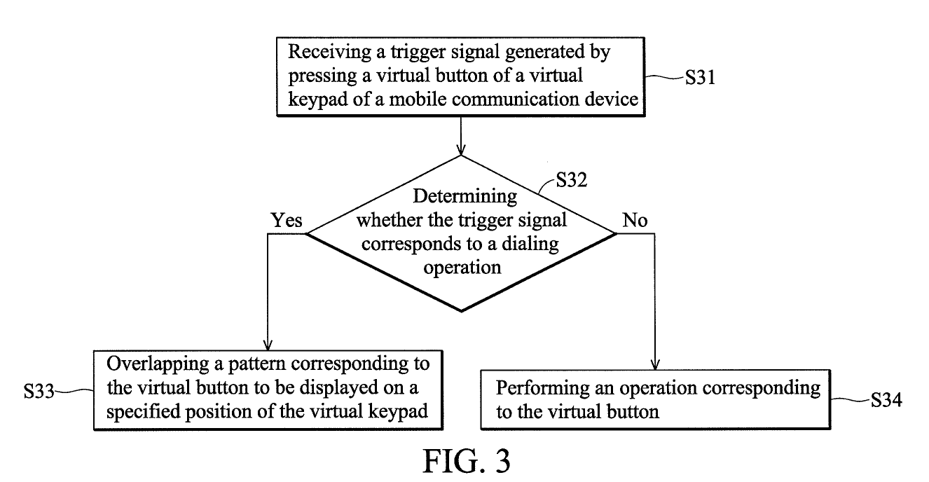

FIG. 3 is a flowchart of a method for displaying dialing information of the present invention.

A trigger signal generated by pressing a virtual button of a virtual keypad of a mobile communication device is received (step S31). It is determined whether the trigger signal corresponds to a dialing operation (step S32). If the trigger signal corresponds to the dialing operation, a pattern corresponding to the pressed virtual button is overlapping displayed on a portion of the virtual keypad (step S33), such that the pattern corresponding to the pressed virtual button can be overlapping displayed on the virtual keypad, as shown in FIG. 2. In an embodiment, as shown in FIG. 2, if the trigger signal does not correspond to the dialing operation, an operation corresponding to the pressed virtual button is performed (step S34).

In an embodiment, the pattern corresponding to the pressed virtual button is translucently displayed on a specific portion of the virtual keypad, so that the patterns on the virtual buttons can be clearly recognized.

In an embodiment, the method for displaying dialing information of the application can be achieved by using the techniques comprising the techniques for making an object translucent such as alpha blending, texture mapping, and the like, or the techniques for overlapping displaying such as JAVA script, cascading style sheets (CSS), and the like.

In the above embodiments, the patterns on the virtual buttons comprise numbers or symbols (“#” and “*”, for example).

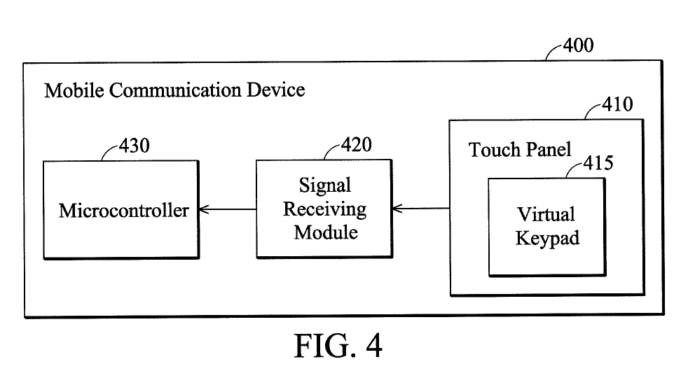

FIG. 4 is a schematic view of a mobile communication device of the present invention.

A mobile communication device 400 comprises a touch panel 410, a signal receiving module 420, and a microcontroller 430. The touch panel 410 comprises a display area 415 in which a virtual keypad providing plural virtual buttons is built. The signal receiving module 420 receives a trigger signal generated by pressing one of the virtual buttons of the virtual keypad located at the display area 415. The microcontroller 430 receives the trigger signal from the signal receiving module 420 and determines whether the trigger signal corresponds to a dialing operation. If the trigger signal corresponds to the dialing operation, the microcontroller 430 overlapping displays a pattern corresponding to the pressed virtual button on a portion of the display area 415, so that the pattern corresponding to the pressed virtual button can be overlapping displayed on the virtual keypad, as shown in FIG. 2.

In an embodiment, if the trigger signal does not correspond to the dialing operation, the microcontroller 430 performs an operation corresponding to the virtual button.

In the above embodiments, the patterns on the virtual buttons comprising numbers or symbols (“#” and “*”, for example).

In some embodiments, the touch panel 410 further comprises another display area (a second display area, for example) (not shown) for displaying contact information, such as a contact name in a contact list and a phone number in a call history, corresponding to numbers or symbols of the pressed virtual buttons on the virtual keypad. In an embodiment, the size of the display area 415 is at least two times larger than the size of the second display area to reduce accidental touch.

Methods and devices of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a mobile communication device, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a mobile communication device, the machine becomes an apparatus for practicing and embodiment of the disclosure. When implemented on a general-purpose processor, the program code combines with the processor to provide a unique apparatus that operates analogously to specific logic circuits.

While the disclosure has been described by way of example and in terms of the embodiments, it is to be understood that the disclosure is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A method for displaying dialing information, comprising:
receiving a trigger signal generated by pressing a virtual button of a virtual keypad of a mobile communication device;
determining whether the trigger signal corresponds to a dialing operation; and
if the trigger signal corresponds to the dialing operation, overlapping displaying a pattern corresponding to the pressed virtual button on a portion of the virtual keypad.

2. The method for displaying dialing information as claimed in claim 1, wherein the pattern corresponding to the pressed virtual button is overlapping displayed on a specific portion of the virtual keypad.

3. The method for displaying dialing information as claimed in claim 1, wherein the pattern corresponding to the pressed virtual button is translucently displayed on a specific portion of the virtual keypad.

4. The method for displaying dialing information as claimed in claim 1, further comprising a step of performing an operation corresponding to the pressed virtual button if the trigger signal does not correspond to the dialing operation.

5. The method for displaying dialing information as claimed in claim 1, wherein the pattern represents a number.

6. The method for displaying dialing information as claimed in claim 1, wherein the pattern represents a symbol.

7. The method for displaying dialing information as claimed in claim 1, wherein the pattern represents a phone number.

8. The method for displaying dialing information as claimed in claim 1, further comprising a step of displaying a display area for displaying contact information corresponding to the pattern.

9. The method for displaying dialing information as claimed in claim 1, wherein the contact information comprising a contact name in a contact list or a phone number in a call history.

10. A mobile communication device, comprising:
a touch panel, comprising a first display area for displaying a virtual keypad comprising plural virtual buttons;
a signal receiving module, receiving a trigger signal generated by pressing one of the virtual buttons; and
a microcontroller, receiving the trigger signal from the signal receiving module, determining whether the trigger signal corresponds to a dialing operation, and, if the trigger signal corresponds to the dialing operation, overlapping displaying a pattern corresponding to the virtual button on a portion of the virtual keypad.

11. The mobile communication device as claimed in claim 10, wherein the pattern corresponding to the pressed virtual button is overlapping displayed on a specific portion of the virtual keypad.

12. The mobile communication device as claimed in claim 10, wherein the pattern corresponding to the pressed virtual button is translucently displayed on a specific portion of the virtual keypad.

13. The mobile communication device as claimed in claim 10, wherein the microcontroller performing an operation corresponding to the pressed virtual button if the trigger signal does not correspond to the dialing operation.

14. The mobile communication device as claimed in claim 10, wherein the pattern represents a number.

15. The mobile communication device as claimed in claim 10, wherein the pattern represents a symbol.

16. The mobile communication device as claimed in claim 10, wherein the pattern represents a phone number.

17. The mobile communication device as claimed in claim 10, wherein the touch panel further displaying a second display area for displaying contact information corresponding to the pattern.

18. The mobile communication device as claimed in claim 17, wherein the contact information comprising a contact name in a contact list or a phone number in a call history.

19. The mobile communication device as claimed in claim 17, wherein the first display area is at least two times larger than the second display area.

20. A computer-readable storage medium containing instructions for performing the method for displaying dialing information as claimed in claim 1.
